(19) United States
(12) Patent Application Publication
(10) Pub. No.: US 2005/0076382 A1
(43) Pub. Date: Apr. 7, 2005

(54) Method and system for managing a wireless access transceiver in a broadband network

(76) Inventor: Angelo Blone, Lawrenceville, GA (US)

Correspondence Address: ARRIS INTERNATIONAL, INC, 3871 LAKEFIELD DRIVE, SUWANEE, GA, 30024, US

(21) Appl. No.: 10/932,788

(22) Filed: Sep. 2, 2004

Related U.S. Application Data
(60) Provisional application No. 60/499,541, filed on Sep. 2, 2003.

(51) Int. Cl. H04N 7/173; H04J 1/00; H04H 1/04

(52) U.S. Cl. 725/107

(57) ABSTRACT

A processor receives health signals from sensors in a wireless transceiver that represent measured values of operating condition parameters. The signals are sent from the processor to and combined with RF session data as either out-of-band digital signals or in-band RF signals as a composite signal to a user device such as a cable modem at an RF signaling interface of the transceiver. Decoder circuitry at the user device extracts information contained in the received health signals and converts them into format, such as MIB variable values, recognizable by the modem's processor. The MIBs are then used by the cable modem's monitoring and alarm feature set to notify the user or technician on the operating conditions at the wireless transceiver.

### CROSS REFERENCE TO RELATED APPLICATION

This application claims priority under 35 U.S.C. 119(e) to Bione, U.S. provisional patent application No. 60/499,541 entitled “Management of MMDS XCVR over DOCSIS,” which has a filing date of Sep. 2, 2003, and is incorporated herein by reference in its entirety.

### FIELD OF THE INVENTION

The present invention relates generally to telecommunications, and more particularly to transmission of data traffic over a wireless communication network.

### BACKGROUND

Community antenna television (“CATV”) networks have been used for more then four decades to deliver television programming to a large number of subscribers. Increasingly, CATV networks are used by providers to provide data services to subscribers. For example, cable modems used in a broadband cable modem termination system (“CMTS”) are capable of transmitting and receiving Internet data using the Data Over Cable Service Interface Specification (“DOCSIS”) protocol. DOCSIS provides a standard that allows network devices made by different vendors to communication with one another.

DOCSIS, and other data over cable services, are typically provided using the CATV network as described above. Such a network typically comprises a system or centrally located CMTS devices a cable modem at each subscriber’ location. These components are typically interconnected by coaxial cable that is strung from a user to a network node, and from the network node to the CMTS. While this is a simplified description, and a typical installation is more complex, this is basically how the cable data network is connected.

Since the CATV network has been expanding since the 1960's, there are many millions of homes and offices that are being ‘passed’ by the CATV network. This phraseology is used to describe the number of subscribers to whom CATV connectivity is readily available, even though given residents choose not to subscribe to cable TV or data services.

For individuals, families and businesses that are passed, and that subscribe, the quality of service facilitated by the CATV networking technology is high, there are some would-be subscribers that are not passed by the CATV network. These are typically rural residents not close enough to an urban or suburban area. Since these residents tend to be geographically far apart as compared to urban or suburban dwellers, the density of these residents in a given geographical area do not provide the economies of scale such that a cable television/data provider can justify the large expense of procuring real estate interests and equipment costs in providing wired service to these residents.

These residents and businesses typically have access to telephone services, as the government has required telephone operators to provide service to residents even located in remote rural location. Thus, these residents and businesses can have Internet connectivity as well as satellite television services. However, since satellite television may not have any competition, television rates may be higher than for residents of more densely populated regions. Moreover, ‘dial-up’ Internet service is much slower than that provided with a cable data network system. Digital Subscriber Line (“DSL”) may be available to the rural telephone service customer, although it typically is not. Satellite subscribers may have the capability to receive data from the Internet via the satellite link, but these users typically provide data in the upstream direction over the dial-up modem. With respect to a broadband connection, this is slow and ties up the telephone line.

To alleviate this lack of broadband connectivity, cable providers offer a wireless system that transmits using microwaves. Multipoint Microwave Distribution System (“MMDS”), also know as Multi-channel Multi-point Distribution System and wireless cable, is a wireless broadband technology for Internet Access.

The typical system for transmitting and receiving MMDS broadband signals is with a microwave antenna attached to a subscriber's cable modem, or other similar communication device. The antenna device, typically mounted on the roof of a subscriber's house, contains circuitry for converting the RF signal that a cable modem communicates with a broadband network, to or from a microwave frequency signal. The MMDS microwave antenna is pointed towards an antenna operated by the broadband service provider, the provider's antenna being coupled into the wired network at the location that is nearest to the resident. It will be appreciated that the subscriber's antenna may be connected to another relay antenna that amplifies the signal before forwarding to either another relay antenna or to the operator's central location, such as a head end.

While MMDS has provided a way to deliver broadband access to rural users, as with all technology equipment, malfunctions can occur. A broadband user who connects to the Internet using a cable modem over a wired network, a DSL user who connects to a DSL access module over a wired network, or even a user who connects using a standard dial-up modem, typically have lights, sounds, or other indicators that provided information regarding the health of the modem (or other connection device) and the network connection in general. For example, when the device has power being adequately supplied, a light on the front of the device may illuminate, indicating as much. When a network connection is active, another light may illuminate indicating as much. And when data is being transmitted or received, another light may illuminate indicating as much.

However, with the typical MMDS system, the cable modem, which may, for example, utilize the lights as discussed for providing information regarding the connection of the device and connection, may not be sent information regarding the total health of the wireless connection.

For example, if the cable modem is receiving power from its power supply, the power on/off light is illuminated. If the connection to the MMDS antenna is present, the corresponding light is illuminated. However, since the cable modem only interfaces with the MMDS antenna on the network side, the modem itself typically cannot determine where a problem lies when the subscriber's computer is not receiving or transmitting data. This is because the lights on the modem indicate that there is not a problem.

Problems with the network communication link can result from a variety of causes. For instance, if power to the antenna and its internal circuitry is not provided, transmission and reception of wireless signals will not occur. However, since the modem is still connected to the antenna, it may not indicate that a problem exists. Moreover, even if power is present at the MMDS receiver and data is being transmitted and received, the data rate may be slow due to a variety of factors, such as poor atmospheric conditions, extreme heat or cold at the antenna, causing circuits to not function properly, etc.

However, since MMDS transceiver/antennas have not been designed to address this situation, the cable modem user is usually unable to self-diagnose a problem with slow or no data transfer. Thus, there is a need for a method and system for providing a cable modem user with status signals that indicate the health of an MMDS and the signals being transmitted/received thereby.

### SUMMARY

An aspect provides status signals from an MMDS transceiver/antenna, to a cable modem connected thereto, such that the status of the transceiver and signal health is presented to a user of the modem. The status signals are provided from the transceiver on the roof to the modem connected with a personal computer, for example, via the radio frequency (“RF”) connection between them.

The health status signals can be provided between the antenna and the modem using out-of-band (outside the RF range that is used for carrying data signals) baseband signaling so as to avoid interference with the RF data signals flowing back and forth between the modem and the transceiver/antenna. Thus, the health status and signal quality information reporting capabilities that are designed into DOCSIS equipment and operating systems can be used to facilitate the reporting of the same parameters of the wireless MMDS transceiver/antenna.

In another aspect, in addition to baseband signaling, a modulated inband RF signal could be injected into the RF stream coming from the transceiver to the modem, where inexpensive demodulating circuitry converts the signal to a baseband signal to be used as discussed so that it is integrated into the DOCSIS reporting capabilities.

In another aspect, similar circuitry as described above that provides signaling from the transceiver to the modem, can be used to provide signaling from the modem to the transceiver, thus facilitating control of the transceiver by the modem and instructions relayed to it.

To implement these aspects, sensors can be placed in the transceiver for sensing the state of certain predetermined health statistic/management data parameters. For example, a thermocouple placed in the transceiver can provide an electrical signal representative of the temperature inside the transceiver and of the circuitry therein. An RF power monitor circuit can measure the outgoing and incoming RF power from and to the transceiver and provide a signal to the modem reflecting these power measurements. Similarly, an AC power (or what ever mode power is supplied to the transceiver's internal circuitry) can provide a signal representing whether the transceiver is being adequately supplied with power. In addition, the transceivers serial number, model number and other fixed data, can be provided to the modem, such that these values can be sent to the service provider when reporting problems with the transceiver. The information sent from the transceiver to the modem can be received by the processor that is part of a typical cable modem and can be displayed using the setup and management software used by the modem.

### BRIEF DESCRIPTION OF THE DRAWINGS

FIG. 1 illustrates a broadband cable data system using a wireless transceiver to connect with a network.

FIG. 2 illustrates circuitry used in a wireless transceiver to measure and transmit data to a user device.

FIG. 3 illustrates circuitry used in a broadband modem to receive health statistic management data from a wireless transceiver.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

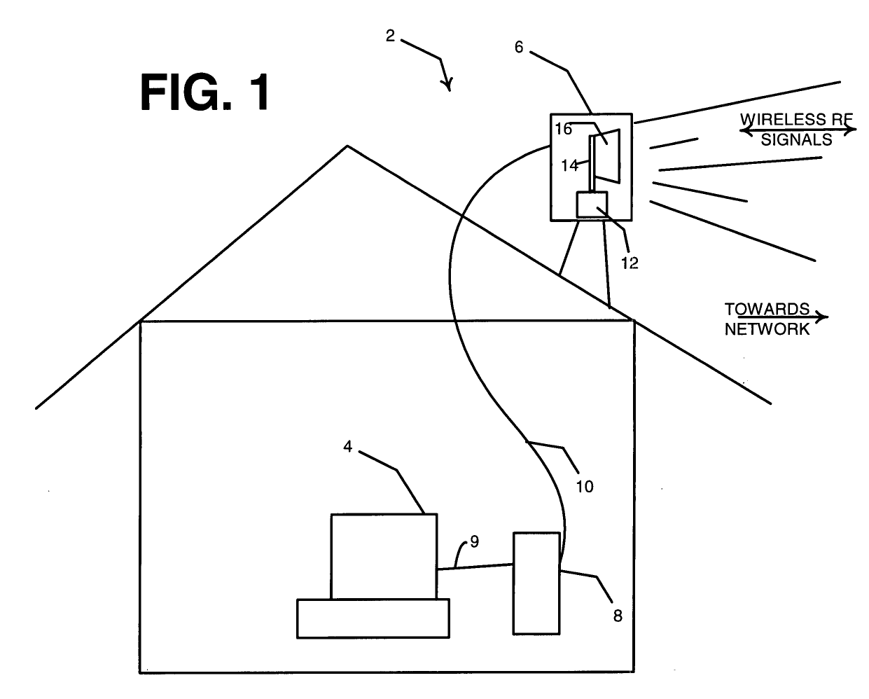

Turning now to the figures, FIG. 1 illustrates a system 2 for connecting a user device 4, such as a personal computer, PDA or television, for example, to a broadband network using a wireless transceiver 6. Preferably, a cable modem 8, connected with computer 4 via an Ethernet link 9, USB link, or similar link known in the art for digitally connecting devices, is used to interface the computer 4 with the network via the wireless transceiver 6. However, it will be appreciated that interface device 8 may be other devices, such as, for example, a DSL modem transmitting to a transceiver at a telephone service provider's central office facilities. Transceiver 6 and modem 8 are preferably connected together with coaxial cable 10, or other appropriate link. Transceiver 6 is typically pointed toward another transceiver at a wireless endpoint, or at a relay station that boosts a received signal before forwarding to another transceiver or relay.

Transceiver is preferably an MMDS microwave transceiver that is directional for purposes of signal strength, as know in the art of electromagnetic wave propagation. Thus, if environmental factors, such as wind, birds, or falling tree limbs cause the antenna of transceiver 6 to move from its direction that provides maximum transfer of wireless signal energy with another transceiver or relay station, then signal strength may drop. This will typically result in decreased data rates, as error correction algorithms may cause wireless traffic to be retransmitted until information is accurately transmitted.

If the antenna of transceiver is equipped with an RF signal power meter, the meter can measure the RF power of a received signal and output a power measurement signal that is representative of the measured RF power. This power measurement signal can then be used by a processor in modem 8 to cause a warning light to illuminate when RF power drops below a predetermined level, and/or to display the actual RF power with management software on computer 4.

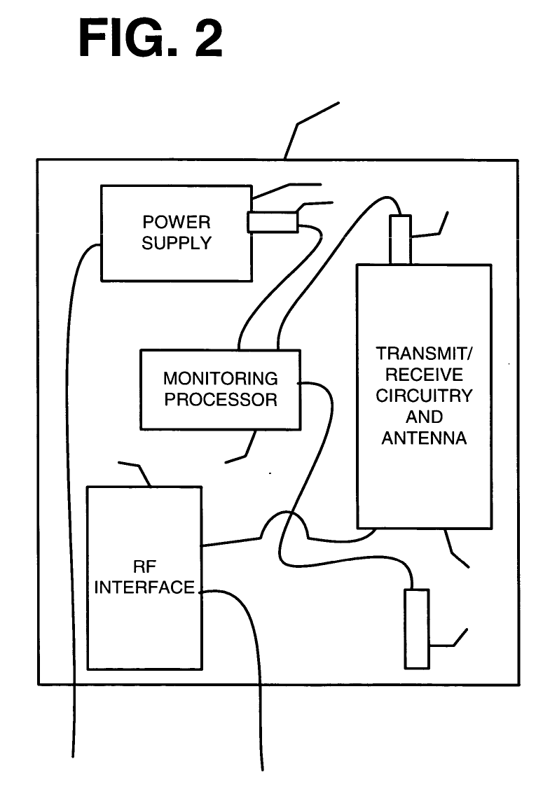

Turning now to FIG. 2, a block diagram of the main circuit elements that facilitate the measuring and monitoring of health statistic management data parameters at transceiver 6 are shown. A power meter 18 is used to measure output power from the power supply 20 that provides power to the other circuits of transceiver 6. Power meter 18 may be any meter that is appropriate for the type of power being supplied to the transceiver (AC or DC, for example) known in the art for measuring a power signal and converting it into a signal that can be monitored by signal monitoring processor 22.

RF power meter 24 measures the amount of data that is being transmitted or received through RF transmitter/receiver circuitry 26, and sends a signal that represents the RF power to processor 22, that preferably includes digital-to-analog conversion capabilities as known in the art. Power meter 24 may measure RF power in both incoming and outgoing directions.

Temperature measuring device 28, which is preferable a thermocouple, senses the temperature inside the enclosure of transceiver 6, and outputs a signal that is proportional thereto. As known in the art, thermocouple 28 typically is placed as a resistor between a regulated voltage and a monitoring pin, so that a change in voltage at the monitoring pin of processor 22 is converted into a signal representing the temperature to which the thermocouple is exposed. In addition, processor 22 can be electronically ‘stamped’ with a model number and a serial number, so that it can be readily correlated with a particular batch of devices. Based on historical data related to particular batches of devices, a technician may know whether a particular device is prone to certain defects, thus speeding the diagnosis of a problem.

RF/signaling interface 30 receives a signal from processor 22 at pin 32 and connects with transceiver circuitry 26—typically RF amplifiers and related circuitry—to provide a composite signal to the user's cable modem at pin 34 along preferably coaxial cable 36. RF interface passes the RF signals between the modem and transceiver 6 unaltered, and combines health statistic signals with the RF signals.

In the preferred embodiment, in which the MMDS transceiver 6 is not powered over the coax link 36, a baseband signal is injected at the MMDS transceiver for detection at the DOCSIS modem. This signal could be standard RS-232 formatting (8 bits, parity, stop bit, etc) at a fairly low baud rate (e.g. 2400 baud). Since the baseband signal appears almost as a DC component to the RF domain, also referred to as out-of-band because the low frequency component is outside the frequency bandwidth range of the RF component, decoupling this signal is from the RF portion at the DOCSIS cable modem is straightforward and known in the art. It will be appreciated that processor 22 may include analog-to-digital converters for converting measurements of certain parameters, for example temperature from thermocouple 28 to digital signals.

Another approach for transporting the health statistic management data to the DOCSIS modem is by radio frequency (“RF”) or inband signaling. A modulated RF carrier using, for example, AM, FSK, BPSK, is injected by RF/signaling interface 30 into the signal stream that is sent to the DOCSIS modem. This signal stream is then converted back to a baseband signal for use at the modem.

Inexpensive technologies available in the art demodulate and decode this RF stream. High volume low cost receiver designs such as those in pocket pagers, garage door and other wireless RF devices, for example, may be used.

It will be appreciated that power supply 20 may receive power from a stand-alone power source, or from the coaxial cable 36 that connects the cable modem to the transceiver 6. If the transceiver receives power from coaxial cable 36, the baseband frequency used to communicate health statistic signals from the transceiver to the cable modem along the coaxial cable may need to be raised higher than the power supply frequency so that the signals do not interfere with one another.

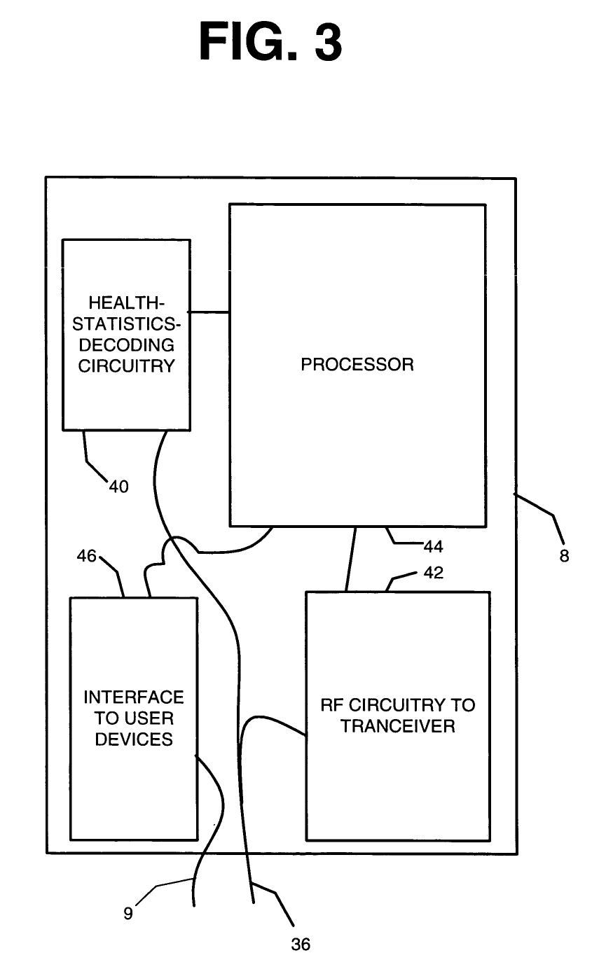

Turning now to FIG. 3, a block diagram of a cable modem device 8 modified to receive health statistics from a wireless transceiver is shown. As discussed above in reference to FIG. 2, wireless transceiver 6 communicates with cable modem 8 via preferably coaxial link 36. Link 36 typically carries RF signals containing data back and forth between transceiver 6 and modem 8. Also as discussed above, health statistics, as measured and provided from transceiver 6 to modem 8, are also received on link 36. Inside modem 8, link 36 is electrically coupled to health statistics decoding circuitry 40 and RF circuitry transceiver 42. A preferably high pass filters at RF circuitry transceiver 42 passes only the DOCSIS RF data received by transceiver 6. However, it will be appreciated that the health statistics signal received on link 36 may be at frequencies high than the DOCSIS signal. Accordingly, if such is the case, a high pass or pass band filter may be used to separate the DOCSIS signal from the composite signal on link 36 to RF circuitry 42.

The health statistics decoding circuitry 40 extracts the health signal from the composite signal received on link 36 and outputs a data stream containing the health statistics information to the cable modem's 8 internal processor 44. Decoding circuitry 40 may include an RF receiver and demodulator if the health signal received on link 36 is an RF modulated signal, or a digital conditioning circuit if the health signal received on the coaxial link is a digitally coded signal. The conditioned or demodulated signal is provided to processor 44, which interprets the data contained in the health signal and assigns them to management information base (“MIB”) variables and alarms that correspond to predetermined health statistics. These health MIBs can then be recognized by existing DOCSIS monitoring features and provided to user device interface 46 along with the DOCSIS network session data. MIBs are known in the art. Interface 46 is preferably an Ethernet port for connecting with user devices such as a computer, PDA or other similar device. Interface 46 may also be a USB interface, or other similar data communication protocol known in the art.

Thus, DOCSIS data is received and demodulated by RF transceiver 42 and the health signal is received from processor 44 at interface 46, both being combined into a signal provided to the user device that can then not only provide DOCSIS data associated with a user's network session, but also the health of the wireless transceiver that facilitates the session can also be displayed and acted upon.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

1. A system for monitoring the health of a wireless transceiver coupled to a user device in a wireless network comprising:
means for measuring one or more health parameters of the transceiver;
means for converting measurements corresponding to the one or more health parameters to one or more corresponding health data signals;
means for transmitting the health data signals to the device; and
interface means for receiving the health data signals at the device and converting the signals into a format that is recognizable by the user device.

2. The system of claim 1 wherein the user device is a cable modem.

3. The system of claim 1 wherein the transceiver and the device are coupled with a coaxial cable.

4. A method for monitoring the health of a wireless transceiver coupled to a user device in a wireless network comprising:
step for measuring one or more predetermined health parameters at the wireless transceiver;
step for generating one or more health data signals representing the measured values that correspond to the predetermined health parameters;
step for transmitting the health data signals to the user device;
step for extracting the measured values from the health data signals;
step for converting values corresponding to the measured values into a predetermined format recognizable by the user device; and
providing the measured values in the predetermined format to the user device.
